(19) United States
(12) Patent Application Publication
(10) Pub. No.: US 2014/0016032 A1
(43) Pub. Date: Jan. 16, 2014

(54) VIDEO SIGNAL PROCESSING CIRCUIT

(71) Applicant: Opto Media Technology Inc., Hsinchu County (TW)

(72) Inventor: Hui-Tsuo Chou, Hsinchu County (TW)

(21) Appl. No.: 13/942,675

(22) Filed: Jul. 15, 2013

Related U.S. Application Data
(60) Provisional application No. 61/671,908, filed on Jul. 16, 2012.

(51) Int. Cl. H04N 7/01

(52) U.S. Cl. CPC H04N 7/0125
USPC 348/441

(57) ABSTRACT

A video signal processing circuit includes a graphics processing unit (GPU) and an optical transmitter. The GPU receives an electrical video signal having a standard format, and transforms the electrical video signal into an electrical control signal for controlling a display device. The optical transmitter electrically connects to the GPU for receiving the electrical control signal, so as to transform the electrical control signal into an optical signal and emit the optical signal.

### CROSS-REFERENCE TO RELATED APPLICATIONS

This application claims the benefit of the filing date priority of a co-pending U.S. Provisional Application No. 61/671,908 filed on Jul. 16, 2012, the disclosure of which is incorporated herein by reference in its entirety.

### BACKGROUND

1. Field of the Invention

The present invention relates to a video signal processing circuit, and more particularly, to a video signal processing circuit using optical signals to achieving high speed data transmission.

2. Related Art

Regarding to a video panel in the modern mainstream, for example a LCD panel or a LED panel, the color level of each pixel is controlled by digital signals. As the LCD panel utilized to the portable electronic device, for example a laptop computer, the control signals are transmitted from the mainboard processing image data to the driving circuit of the display by parallel transmission. Take RGB color model as an illustration; 6 bit is used to define color level of red light, green light, or blue light, i.e. 18 signal lines are required to transmit data. Beside, 3 signal lines are required for control signals and 1 signal line is required for clock signal. 22 signal lines are required by parallel transmission. Problems, such as signal line arrangement or timing skew among signal lines might result.

With the development of the semiconductors, the clock rate of integrated circuits becomes higher and higher, up to 1 GHz, to process electrical signal transmission. Therefore, transmitting large quantity of data by serial transmission is now practicable to deal the problem of signal line arrangement or timing skew. And LVDS (low-voltage differential signal) standard was set for the signal transmission interface of LCD panel. LVDS transmission is based on TIA/EIA-644 standard; each lane requires two signal lines to deal the fully-differential transmission. LVDS standard is adopted by 18 bit color depth display in the modern mainstream. According to LVDS standard, a multiplexer is utilized to perform serial data transmission instead of parallel data transmission; therefore, through the LVDS interface only 8 signal lines (4 pair of lanes) are required instead of 22 signal lines. LVDS standard is widely adopted to the displays in the modern mainstream.

Recently, LCD display is equipped with higher resolution and more color levels, and image refresh rate is raised to 120 Hz-240 Hz from 60 Hz, that is, in the same time period data processed by LCD display is larger than that by an old display. For a LCD panel having 1920×1080 resolution and 10 bit color depth, 24 pair lanes (48 signal lines) are required for LVDS standard. Through LVDS, data transmission is performed under fixed frequencies; signal energy is concentrated to some band, which causes serious EMI problems.

4K resolution video panel gradually become mainstream. A 4K resolution video panel has 3840×2160 resolution and 240 Hz refresh rate, such that the data transmission speed requirement of the interface of LCD display is up to 60 Gbps. In view of the problems in LVDS, commercial solution is to use V-by-One™ interface standard developed by THine Electronics, Inc.™. V-by-One™ adopts equalizers to control the signal quality received by receiver, clock-data recovery (CDR) technology is also used to solve the problem caused by timing skew, and the signal line for transmitting clock signal is not required anymore. Clock signal transmission is not required, such that EMI is eliminated. Adjustment to data transmission speed is applicable, such that total power consumption can be reduced. V-by-One™ can be integrated into LVDS circuit, such that seamless transition from LVDS to V-by-One™ is possible. Data transmission speed of each single lane of V-by-One™ is up to 3.5 Gbps.

FIG. 1 is a block diagram of the video signal processing circuit 100 of a 4K resolution video panel in the art. The video panel 180 has 4K resolution, 10 bit color depth, and 240 Hz refresh rate. The video signal processing circuit 100 receives an electrical video signal having a standard format, and transforms the electrical video signal into an electrical control signal for controlling a display device. The standard format is selected from the consisting of RGB format, YPbPr format, Composite format, S-Video format, HDMI format, NTSC format, and PAL format. The RGB, YPbPr, Composite, S-Video, and HDMI can be decoded by an image decoder 111, so as to transform those signal formats into one single format and then transmit the transformed signals to a graphics processing unit (GPU) 120. Commercial TV service provider utilizes NTSC or PAL format signals to transmit or broadcast TV signals. The NTSC or PAL format signals is received by a tuner 112 and then transmitted to the GPU 120. It is noted that the image decode 111 and tuner 112 can be integrated into the GPU 120. Separated GPU 120, image decode 111, and tuner 112 in the drawing hereinto is only an illustration. The timing controller 150 receives the electrical control signal, and controls the rows driver 160 and the columns driver 170 accordingly, so as to drive the video panel 180 to display images. The timing controller 150, the rows driver 160, the columns driver 170, and the video panel 180 are basic parts of a display device in the art.

Data transmission speed is up to 60 Gbps, 96 pairs of lanes (192 signal lines) are needed if adopting LVDS, and the circuit in FIG. 1 adopts V-by-One interface to reduce number of signal lines. As shown in FIG. 1, each high-speed video data transmitter (HS TX) 131, 132 . . . 138 has two V-by-One lanes, each V-by-One lane transmits data in serial from 6 pairs of parallel LVDS lanes. At the receiving end, 8 high-speed video data receivers 141, 142 . . . 148 recover data into LVDS standard control signals to control timing controller 150. As shown in FIG. 1, only 16 pairs of lanes (32 signal lines) are required to transmit control signals of 4K resolution video panel.

It is predictable that the resolution of video panel will be greatly developed in the future, such that it could be helpful for minimization and portability of image display if reduce the number of signal lines of video signal transmission. If data transmission speed in each lane can be greatly raised, the aforementioned object will be more easily achieved.

### SUMMARY OF THE INVENTION

In view of the aforementioned problems, the present invention provides a video signal processing circuit using optical signals to achieving high speed data transmission.

In one or more embodiment, a video signal processing circuit includes a graphics processing unit (GPU) and an optical transmitter. The GPU receives an electrical video signal having a standard format, and transforms the electrical video signal into an electrical control signal for driving a display device. The optical transmitter electrically connects to the GPU and receives the electrical control signal, so as to transform the electrical control signal into an optical control signal and transmit the optical control signal.

In one or more embodiments, a video signal processing circuit includes a GPU, an optical fiber, an optical transmitter, and a timing controller. The GPU receives an electrical video signal having a standard format, and transforms the electrical video signal into an electrical control signal for driving a display device. The optical transmitter electrically connects to the GPU and receives the electrical control signal, so as to transform the electrical control signal into an optical control signal and transmit the optical control signal. The optical fiber transmits the optical control signal; The optical receiver couples to one end of the optical fiber while the optical transmitter couples to the other end of the optical fiber, wherein the optical receiver receives the optical control signal and directly recovers the optical control signal into the electrical control signal. The timing controller electrically couples to the optical receiver and receives the electrical control signal, so as to generate a driving signal to driving a video panel of the display device.

In one or more embodiments of the present invention, a video signal processing circuit is adopted for receiving an optical control signal to generate a driving signal accordingly for driving a video panel. The video signal processing circuit includes an optical transmitter, and a timing controller. The optical receiver receives the optical control signal and directly transforms the optical control signal into the electrical control signal. The timing controller electrically couples to the optical receiver and receives the electrical control signal, so as to generate a driving signal to driving a video panel of the video panel.

The advantage of the present invention lies in that the video signal processing circuit of the present invention utilizes optical signals to achieving high speed data transmission. The number of the signal lines required to transmitting image data is reduced, such that the size of the display device can be easily minimized. Moreover, compared with the cost of the high speed video data transceiver in the art, the costs of the optical transmitters and the optical receivers are lower, so as to reduce the manufacturing cost of related hardware.

The present invention will become more obvious from the following description of the preferred embodiments taken in conjunction with the accompanying drawings.

### BRIEF DESCRIPTION OF THE DRAWINGS

The present invention will become more fully understood from the detailed description given herein below for illustration only, and thus not limitative of the present invention, wherein:

FIG. 1 is a block diagram of the video signal processing circuit of a 4K resolution video panel in the art.

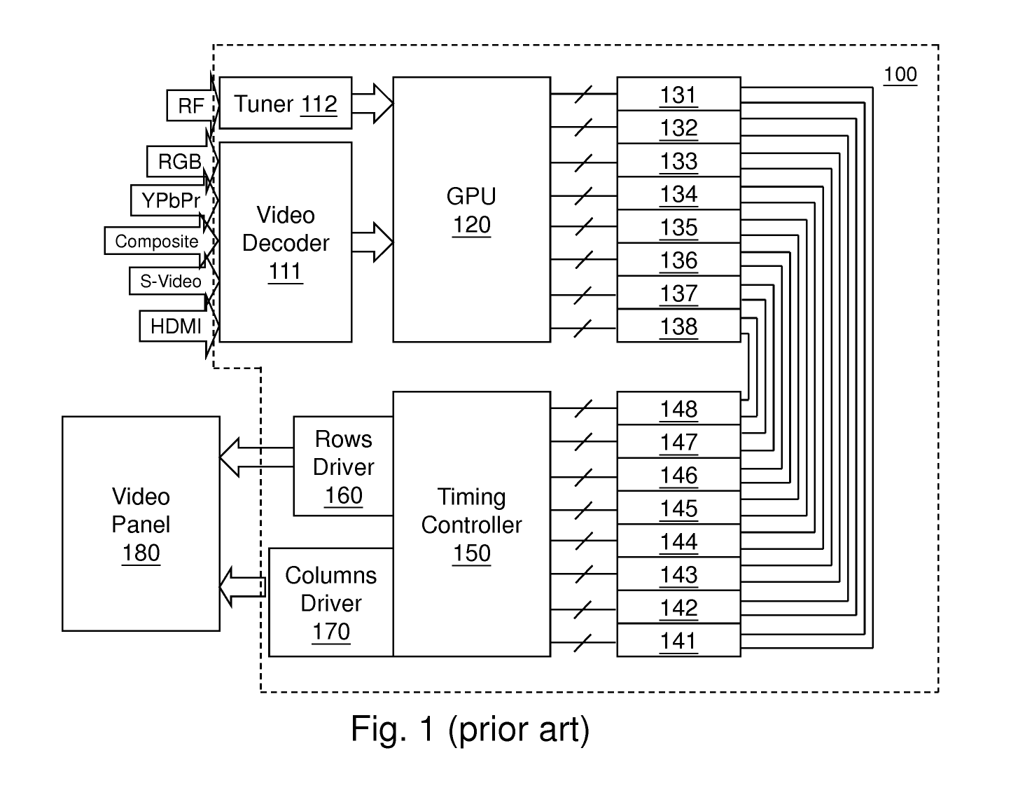

FIG. 2 is a block diagram of the video signal processing circuit according to a first embodiment of this disclosure.

FIG. 3 is a block diagram of the video signal processing circuit according to a second embodiment of this disclosure.

FIG. 4 is a block diagram of the video signal processing circuit according to a third embodiment of this disclosure.

### DETAILED DESCRIPTION OF THE INVENTION

The term hereinafter “coupling” or “connecting” includes direct electrical connection and indirect electrical connection. Therefore, in this disclosure (including claims), the description of “a first device connecting/coupling to a second device” can be interpreted as “a first device electrically connecting/coupling to a second device directly” or “a first device electrically connecting/coupling to a second device indirectly”.

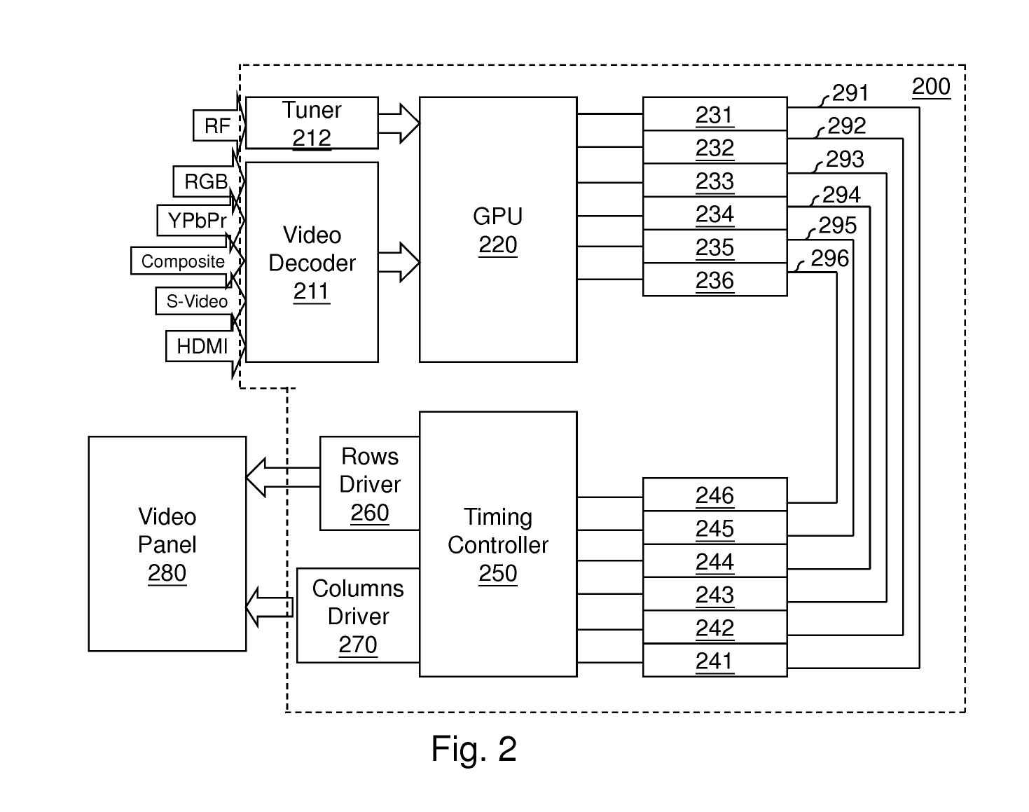

FIG. 2 is a block diagram of a video signal processing circuit 200 according to a first embodiment of the present invention. The video signal processing circuit 200 is used to receive electrical video signals having various standard formats and then transform the electrical video signals into electrical control signals for controlling a display device. The format of the standard video signal includes RGB, YPbPr, Composite, S-Video, HDMI, NTSC, PAL, and the other common used formats. The RGB, YPbPr, Composite, S-Video, and HDMI can be decoded by an image decoder 211, so as to transform those signal formats into one single format and then transmit the transformed signals to a graphics processing unit (GPU) 220. Commercial TV service provider utilizes NTSC or PAL format signals to transmit or broadcast TV signals. The NTSC or PAL format signals is received by a tuner 212 and then transmitted to the GPU 220. It is noted that the image decoder 211 and tuner 212 can be integrated into the GPU 220. Separated GPU 220, image decoder 211, and tuner 212 in the drawing hereinto is only an illustration, not to limit the scope of the claims.

The GPU 220 receives the aforementioned electrical video signals having standard formats, and the transforms the electrical video signals into electrical control signals for controlling the display device. The transformation includes changing the resolution, changing the refresh rate, tuning the color-level, and etc. The detail of the electrical video signal transformation is well understood by a person having ordinary skills in the art, the detailed description of transformation is omitted hereinafter.

Optical transmitters 231 . . . 236 electrically connect to the GPU respectively and receive the electrical control signals. The optical transmitters 231 . . . 236 directly transform the electrical control signals into optical signals and emit the optical signal. Directly transforming or direct transformation in the present invention means that the optical transmitters 231, . . . , 236 transform each bit of data into a corresponding optical signal status (for example, a corresponding wavelength) without other data processing procedure. Moreover, the number of the optical transmitters of the video signal processing circuit 200 is adopted for the 4K resolution video panel 280 as an illustration; the number illustrated is not used to limit the scope of the claims. The number of the optical transmitters required in the video signal processing circuit 200 is determined by data transmission speed required to transmit the video signals and the capacity of the optical transmitter. A person having ordinary skills in the art can easily modified the design to satisfy actual requirement according to the deception of the present invention.

Optical fibers 291, 292 . . . 296 respectively transmit the optical signals. Each optical receiver 241,242, . . . , 246 couples to one end of one optical fiber 291, 292, . . . , 296 while one of the optical transmitters couples to the other end of the optical fiber 291, 292, . . . , 296. Each optical receiver 241, 242 . . . 246 receives the optical signals and directly recovers the optical signals to the electrical control signals. The directly recovering or direct recovery in the present invention means a reversal procedure of directly transforming or direct transformation. More precisely, the optical receivers 241,242, . . . , 246 transform the optical signal status (for example, the wavelength) of each received optical signal into corresponding bit of data of the electrical control signal without other data processing procedure. Similarly, the number of the optical receivers of the video signal processing circuit 200 is adopted for the 4K resolution video panel 280 as an illustration; the number illustrated is not used to limit the scope of the claims.

The timing controller 250 electrically connects to the optical receivers 241, 242 . . . 246, and receives the recovered electrical control signals, so as to generate a driving signal for driving a video panel 280 of the display device. For example, in the video signal processing circuit 200, the timing controller 250 directly controls the rows driver 260 and the columns driver 270, so as to drive the video panel 280 to display images.

In one example, the resolution of the video panel 280 is 4K resolution. That is, the video panel 280 has 3840×2160 pixels and a refresh rate up to 240 Hz. For such a video panel 280, the data transmission speed of the interface of the display device has to be higher than 60 Gbps. The data transmission speed of the optical transmitters 231 . . . 236 can reach 12 Gbps, such that six optical transmitters 231 . . . 236 are adopted in the video signal processing circuit 200 to transmit video data carried by optical signals. The optical signals travel in six optical fibers 291, 292 . . . 296, and then six optical receivers 241, 242 . . . 246 receive video data carried by optical signals. Since the optical transmitters 231, . . . , 236 directly transform the received electrical control signals into optical signals, the GPU 220 has to generate corresponding electrical control signals for each optical transmitters 231, . . . , 236 in 12 Gpbs transmission speed. Among the usually used high speed electrical transmission interfaces, the current mode logic (CML) interface could be a preferable option. Moreover, to a high speed electrical transmission interface, it could be of great benefit if the format of the electrical control signal is fully-differential format, for example, to resist common-mode interference, to duplicate the amplitude of reality signals, to neglect the absolute threshold of signals. Therefore, the format of the electrical control signal can be fully-differential format.

Moreover, to video signal transmission by LVDS or V-by-One standard, the video signal processing circuit 200 utilizes optical transmission to raise image data transmission speed in each single lane, such that the number of lanes required is reduced. Take LVDS interface as an illustration, 128 signal lines are required in the art; take V-by-One interface as illustration, 32 signal lines are required in the art. In this embodiment of the present invention, only 6 signal lines (optical fibers) are required to satisfy 60 Gbps transmission speed. Through optical signal transmission in high speed and long distance data transmission, it could be easily to prevent EMI or EMC. Furthermore, the number of signal lines required is reduced, such that compact design of the display device can be easily achieved. The cost of the optical receiver, the optical transmitter, or the optical fiber is relative low compared with the other interface, such that the video signal processing circuit 200 of the present invention can greatly reduce cost of the hardware compared with V-by-One circuit or other high speed IC.

Regarding to expansion capability, the video signal processing circuit 200 utilizes the optical receiver and the optical transmitter which have transmission speed up to 12 Gbps. If an optical receiver and an optical transmitter which having transmission speed up to 25 Gbps are used to replace the 12 Gbps components, the video signal processing circuit 200 can be adopted by the display device requiring higher data transmission speed.

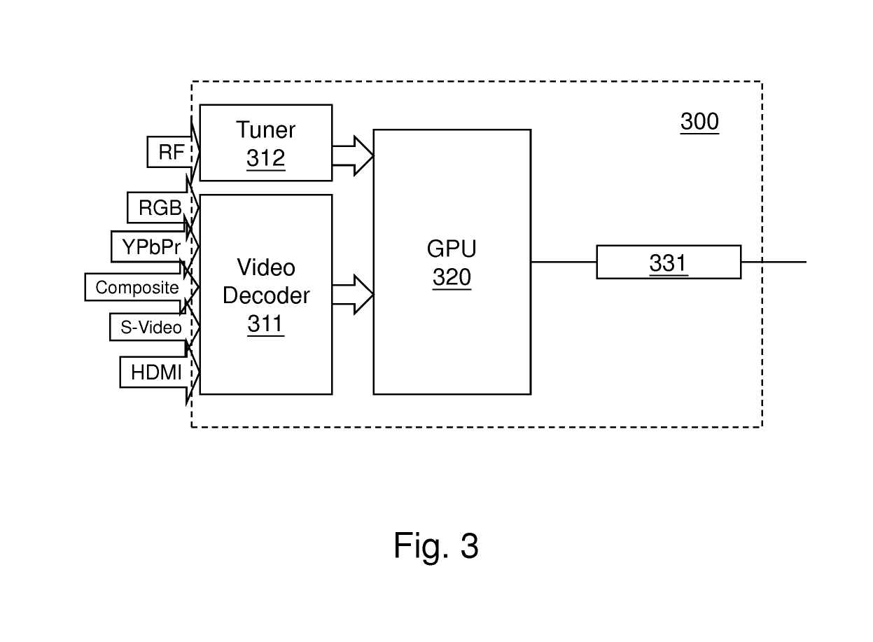

FIG. 3 is a block diagram of the video signal processing circuit 300 according to a second embodiment of this disclosure. The video signal processing circuit 300 includes a GPU 320 and an optical transmitter 331. The video signal processing circuit 300 is used to receive electrical video signals having various standard formats and then transform the electrical video signals into electrical control signals for controlling a display device. The format of the standard video signal includes RGB, YPbPr, Composite, S-Video, HDMI, NTSC, PAL, and the other common used formats. The RGB, YPbPr, Composite, S-Video, and HDMI can be decoded by an image decoder 311, so as to transform those signal formats into one single format and then transmit the transformed signals to the GPU 320. Commercial TV service provider utilizes NTSC or PAL format signals to transmit or broadcast TV signals. The NTSC or PAL format signals is received by a tuner 312 and then transmitted to the GPU 320. It is noted that the image decoder 311 and tuner 312 can be integrated into the GPU 320. Separated GPU 320, image decoder 311, and tuner 312 in the drawing into is only an illustration, not to limit the scope of the claims.

The GPU 320 receives the aforementioned electrical video signals having standard formats, and the transforms the electrical video signals into electrical control signals for controlling the display device. The transformation includes changing the resolution, changing the refresh rate, tuning the color-level, and etc. The detail of the electrical video signal transformation is well understood by a person having ordinary skills in the art, the detailed description of transformation is omitted hereinafter.

The optical transmitters 331 electrically connect to the GPU 320 and receive the electrical control signals. The optical transmitter 331 directly transforms the electrical control signals into optical signals and emits the optical signal. Directly transforming or direct transformation in the present invention means that the optical transmitters 331 transforms each bit of data into a corresponding optical signal status (for example, a corresponding wavelength) without other data processing procedure.

The transmission interface transmitting the electrical control signals needs high data transmission speed if the video panel 380 is equipped with high resolution (for example 4K resolution). Among the usually used high speed electrical transmission interfaces, the current mode logic (CML) interface could be a preferable option. Moreover, to a high speed electrical transmission interface, it could be of great benefit if the format of the electrical control signal is fully-differential format. Therefore, the format of the electrical control signal can be fully-differential format.

In one example, the video signal processing circuit 300 can be a signal processing unit in a video signal processing device, for example a circuit board integrated in a DVD player, a multi-media player, a home entertainment accessory, the circuit board receives video signals in different formats and generate electrical control signals accordingly, and then transmit the electrical control signal to the display device via optical fibers.

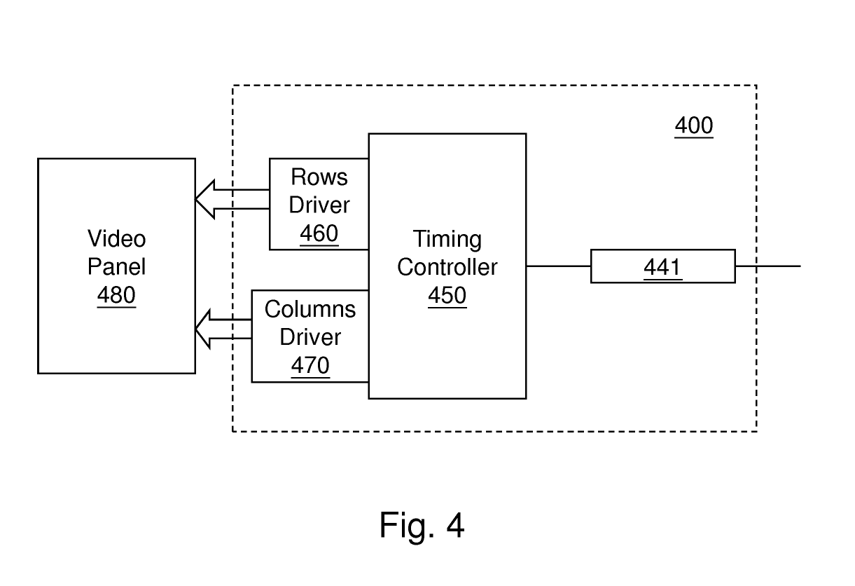

FIG. 4 is a block diagram of the video signal processing circuit 400 according to a third embodiment of this disclosure. The optical receiver 441 receives optical control signals transmitted by an optical fiber, and directly recovers the optical control signal into the electrical control signal. The directly recovering or direct recovery in the present invention means a reversal procedure of directly transforming or direct transformation. More precisely, the optical 441 transforms the optical signal status (for example, the wavelength) of each received optical signal into corresponding bit of data of the electrical control signal without other data processing procedure.

The timing controller 450 electrically couples to the optical receiver 441 and receives the electrical control signal, so as to generate a driving signal to driving a video panel 480 of the display device. For example, in the video signal processing circuit 400, the timing controller 450 directly controls the rows driver 460 and the columns driver 470, so as to drive the video panel 480 to display images.

The transmission interface transmitting the electrical control signals needs high data transmission speed if the video panel 480 is equipped with high resolution (for example 4K resolution). Among the usually used high speed electrical transmission interfaces, the current mode logic (CML) interface could be a preferable option. Moreover, to a high speed electrical transmission interface, it could be of great benefit if the format of the electrical control signal is fully-differential format. Therefore, the format of the electrical control signal can be fully-differential format.

In one example, the video signal processing circuit 400 can be a signal processing unit in a display device, for example, a circuit board integrated in a LED TV, a LCD TV or a computer monitor, and the video signal processing circuit 400 receives electrical control signal via the optical fiber and then drives the video panel to display the corresponding image.

The aforementioned descriptions represent merely the preferred embodiment of the present invention, without any intention to limit the scope of the present invention thereto. Various equivalent changes, alterations, or modifications based on the claims of present invention are all consequently viewed as being embraced by the scope of the present invention.

What is claimed is:

1. A video signal processing circuit, comprising:
a graphics processing unit, receiving an electrical video signal having a standard format, and transforming the electrical video signal into an electrical control signal for driving a display device; and
an optical transmitter, electrically connecting to the graphics processing unit and receiving the electrical control signal, so as to transform the electrical control signal into an optical control signal and transmit the optical control signal.

2. The video signal processing circuit as claimed in claim 1, wherein the standard format is selected from the consisting of RGB format, Composite format, S-Video format, HDMI format, NTSC format, and PAL format.

3. The video signal processing circuit as claimed in claim 1, wherein the format of the electrical control signal is current-mode logic format.

4. The video signal processing circuit as claimed in claim 1, wherein the format of the electrical control signal is fully-differential format.

5. The video signal processing circuit as claimed in claim 1, wherein the resolution of the display device is 4K resolution.

6. A video signal processing circuit, comprising:
a graphics processing unit, receiving an electrical video signal having a standard format, and transforming the electrical video signal into an electrical control signal for driving a display device;
an optical transmitter, electrically connecting to the graphics processing unit and receiving the electrical control signal, so as to transform the electrical control signal into an optical control signal and transmit the optical control signal;
an optical fiber, transmitting the optical control signal;
an optical receiver, coupling to one end of the optical fiber while the optical transmitter coupling to the other end of the optical fiber, wherein the optical receiver receives the optical control signal and directly recovers the optical control signal into the electrical control signal; and
a timing controller, electrically coupling to the optical receiver and receiving the electrical control signal, so as to generate a driving signal to driving a video panel of the display device.

7. The video signal processing circuit as claimed in 6, wherein the standard format is selected from the consisting of RGB format, Composite format, S-Video format, HDMI format, NTSC format, and PAL format.

8. The video signal processing circuit as claimed in 6, wherein the format of the electrical control signal is current-mode logic format.

9. The video signal processing circuit as claimed in 6, wherein the format of the electrical control signal is fully-differential format.

10. The video signal processing circuit as claimed in 6, wherein the resolution of the video panel is 4K resolution.

11. a video signal processing circuit, adopted for receiving an optical control signal to generate a driving signal accordingly for driving a video panel; comprising:
an optical receiver, receiving the optical control signal and directly transforming the optical control signal into an electrical control signal; and
a timing controller, electrically coupling to the optical receiver and receiving the electrical control signal, so as to generate a driving signal to driving a video panel of the video panel.

12. The video signal processing circuit as claimed in claim 11, wherein the format of the electrical control signal is current-mode logic format.

13. The video signal processing circuit as claimed in claim 11, wherein the format of the electrical control signal is fully-differential format.

14. The video signal processing circuit as claimed in claim 11, wherein the resolution of the video panel is 4K resolution.
